(19) United States
(12) Patent Application Publication
(10) Pub. No.: US 2010/0057901 A1
(43) Pub. Date: Mar. 4, 2010

(54) NETWORK MANAGEMENT SYSTEM AND NODE DEVICE AND MANAGEMENT APPARATUS THEREOF

(75) Inventor: Takahiro Ozaki, Tokyo (JP)

Correspondence Address: BLAKELY SOKOLOFF TAYLOR & ZAFMAN LLP, 1279 OAKMEAD PARKWAY, SUNNYVALE, CA, 94085-4040, US

(73) Assignee: Kabushiki Kaisha Toshiba, Tokyo (JP)

(21) Appl. No.: 12/552,143

(22) Filed: Sep. 1, 2009

(30) Foreign Application Priority Data
Sep. 3, 2008 (JP) 2008-226140

(51) Int. Cl. G06F 15/173; G06F 9/44

(52) U.S. Cl. 709/223; 719/318

(57) ABSTRACT

According to one embodiment, a network management system comprises nodes and an apparatus manages a communication network. The node includes generator, buffers, notification module, transmitter, measurement module and controller. The generator generates messages of different levels depending on a type of alarms. The buffers each provided for each of the different levels and temporarily holding the message in a holding period appropriate to the level. The notification module notifies the apparatus of the held message. The transmitter transmits a test signal. The measurement module individually measures the load on the apparatus and the load on the communication network based on a reception time of a reply from the apparatus to the test signal. The controller varies the holding period in the buffers according to the level based on the measured load on the apparatus and the communication network.

### CROSS-REFERENCE TO RELATED APPLICATIONS

This application is based upon and claims the benefit of priority from Japanese Patent Application No. 2008-226140, filed Sep. 3, 2008, the entire contents of which are incorporated herein by reference.

### BACKGROUND

1. Field

One embodiment of the invention relates to a network management system including a managed apparatus (node) forming a network and a management apparatus which manages the managed apparatuses through a network, and a node device and a management device included in this system.

2. Description of the Related Art

In order to maintain a network in a normal state and realize a smooth operation, an apparatus (hereinafter referred to as a management apparatus) which manages states of components (hereinafter referred to as nodes) of the network is provided. Upon occurrence of an event such as occurrence of failure or restoration from failure, the node notifies the management apparatus of a message such as an alarm. The management apparatus understands the state of the network based on the message (hereinafter generally referred to as alarm information). A representative protocol of this kind is Simple Network Management Protocol (SNMP), which can be easily implemented, but various other techniques are also used. This kind of technique features reduction of the load involved in management as a main objective, and related techniques are disclosed in the following references.

Japanese Patent KOKAI Publication No. 2000-278361 discloses a technique of preventing instability caused by the same alarm state by making it a condition of notification that the event continues for a predetermined period, thereby minimizing the event notification traffic.

In Japanese Patent Application KOKAI Publication No. 2001-223694, a management apparatus (NMS server) monitors a load per unit of time, and suppresses alarm notification processing of an alarm notification server (NE server) if the load becomes excessive. According to this document, an alarm notification can be made in consideration of the load on the monitoring apparatus.

In Japanese Patent KOKAI Publication No. 9-214494, a node (a managed apparatus) cannot provide notification of an alarm unless permission is given by a management apparatus. The management apparatus compares processing capacity with the number of received packets monitored by the management apparatus, and gives permission, thereby making it possible to make alarm notification in consideration of the load on the management apparatus. In this document, in particular, the alarm notification completely stops when the permission is denied.

Various approaches for reducing the load on a management apparatus mainly by reducing the traffic when a node notifies a monitoring apparatus of an alarm have been searched for. In recent years, however, the number of monitored objects increases as the scale of a communication system increases, and the load on the monitoring apparatus tends to rise. Depending on the type of a failure which has occurred, many alarms may be notified of during a short period by many nodes (burst). More effective techniques are desired in monitoring the network based on the alarm notification.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a system chart showing an embodiment of a network management system according to the present invention;

FIG. 2 is a functional block diagram showing an embodiment of a management device 3 and nodes N1-Nm of FIG. 1;

FIG. 3 illustrates an example of a failure-alarm conversion table 22;

FIG. 4 illustrates an example of an alarm suppression propriety table 20;

FIG. 5 illustrates an example of a message format of a keepalive message used in an embodiment of the present invention;

FIG. 6 illustrates an example of time information written in the keepalive message of FIG. 5;

FIG. 7 is a flowchart showing a processing procedure from occurrence of a failure in the nodes N1-Nm to storage of alarm information in a buffer;

FIG. 8 is flowchart showing a processing procedure from restoration of a failure in the nodes N1-Nm to transmission of alarm cancellation;

FIG. 9 is a flowchart showing a processing procedure at the time of occurrence of a timeout of a periodic timer in the nodes N1-Nm;

FIG. 10 is a flowchart showing a processing procedure at the time of transmission of a keepalive message in the nodes N1-Nm;

FIG. 11 is a flowchart showing a processing procedure at the time of reception of a keepalive message in the nodes N1-Nm;

FIG. 12 is a flowchart showing a processing procedure for reception and retransmission of a keepalive message in the management device 3; and

FIG. 13 is a timing chart showing alarm occurrence flags, states of an alarm buffer 15, and alarm transmission in chronological order according to an embodiment of the present invention.

### DETAILED DESCRIPTION

Various embodiments according to the invention will be described hereinafter with reference to the accompanying drawings. In general, according to one embodiment of the invention, there is provided a network management system comprises a plurality of nodes forming a communication network and a management apparatus which manages a system including the communication network based on a notification message notified of via the communication network by the nodes. Each of the nodes includes a message generator, a plurality of buffers, a notification module, a test signal transmitter, a measurement module and a holding period controller. The message generator generates notification messages of different levels depending on a type of an alarm that has occurred. The plurality of buffers each provided for each of the different levels and temporarily holding the notification message in a holding period appropriate to the level. The notification module notifies the management apparatus of the held notification message. The test signal transmitter transmits a test signal used to measure a load on the management apparatus and a load on the communication network to the management apparatus. The measurement module individually measures the load on the management apparatus and the load on the communication network based on a reception time of a reply from the management apparatus to the test signal. The holding period controller varies a holding period in the buffers according to the level based on the measured load on the management apparatus and the measured load on the communication network. The management apparatus includes a transmission/reception module configured to receive the test signal, write a response to the test signal in the test signal, and return the test signal to an originating node.

With the above-described configuration, the node device buffers a notification message by alarm level, and notifies the management apparatus of the message with a time lag from occurrence of a failure. In other words, the notification message is not sent promptly after the occurrence of the alarm, but is notified with timing appropriate to each alarm level. That is, an alarm with a higher degree of urgency is notified more promptly, and an alarm which is less important is postponed. It is thereby possible to suppress increase of sudden traffic.

On the other hand, the node periodically transmits a keepalive message, for example, to the management apparatus. Based on a difference between the time of transmission of the keepalive message and the time of reception from the management apparatus, the load on the management apparatus and the communication network can be measured. Further, depending on the length of time during which the keepalive message remained in the management apparatus, the size of the load on the management apparatus can be measured. By subtracting the latter load from the former load, the load on the network alone can be evaluated. By varying the buffering period (data holding period) of a buffer according to the network load, it is possible to realize an operation in which an important alarm is not notified of in a state in which the network load is high. Thereby, alarm notification can be performed in a more effective way.

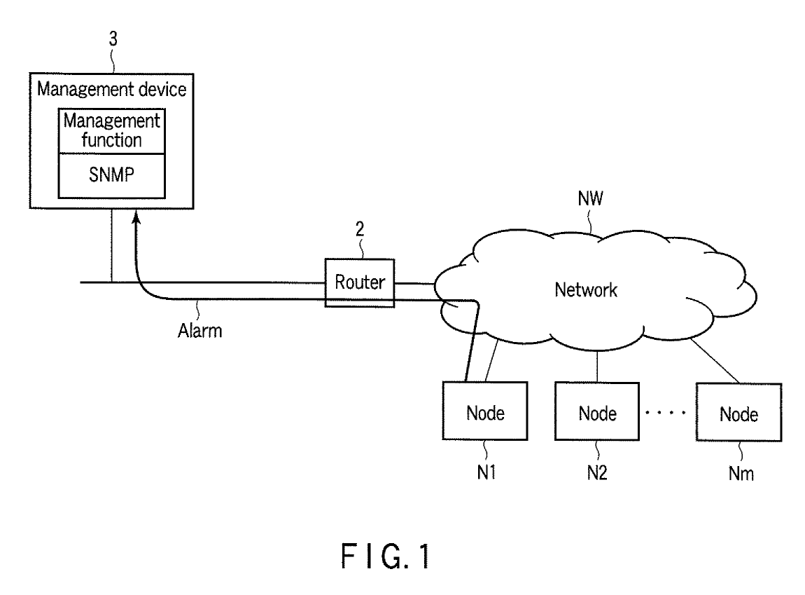

According to an embodiment, FIG. 1 is a system chart showing an embodiment of a network management system according to the present invention. In FIG. 1, a network NW is formed of a plurality of nodes N1-Nm. Each of the nodes N1-Nm performs interactive communications with a management device 3 through a router 2. The management device 3 manages an operational state of each of the nodes N1-Nm, a state of the network NW and a state of a system formed thereof, based on notification information notified of by the nodes N1-Nm. A typical management protocol is SNMP, for example, but is not limited thereto.

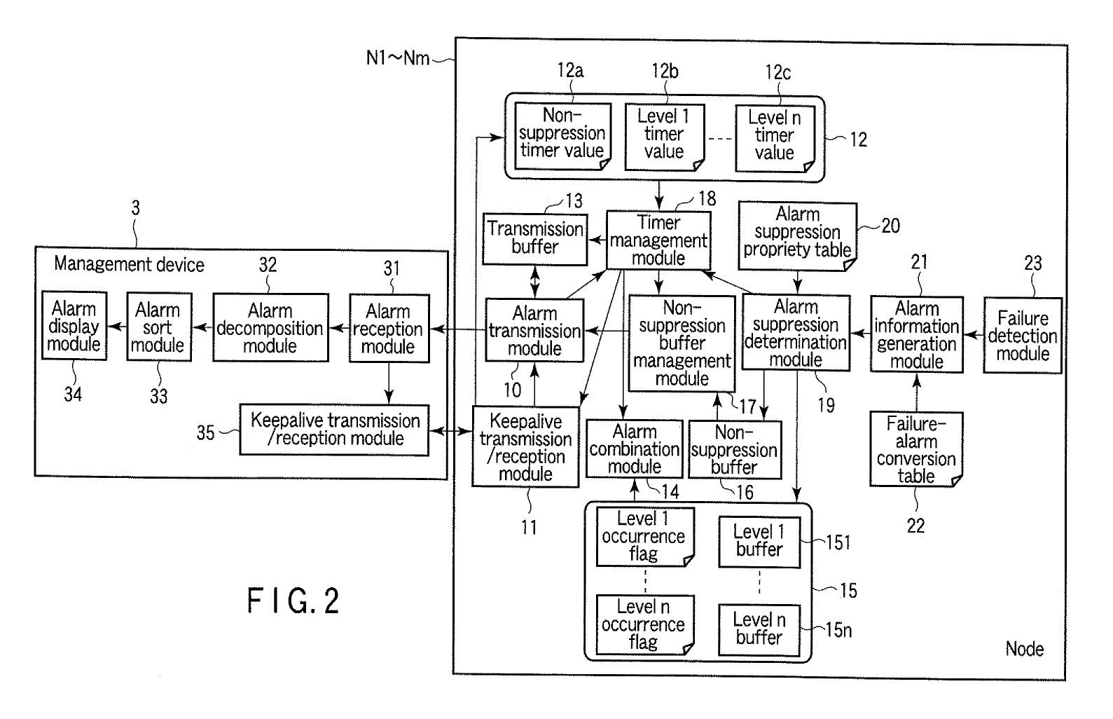

FIG. 2 is a functional block diagram showing an embodiment of the management device 3 and the nodes N1-Nm of FIG. 1. Of these, the nodes N1-Nm include a failure detection module 23, a failure-alarm conversion table 22, an alarm information generation module 21, an alarm suppression propriety table 20, an alarm buffer 15, an alarm suppression determination module 19, an alarm combination module 14, a non-suppression buffer 16, a buffer administrative module 17 for non-suppression, a timer administrative module 18, a timer value table 12, an alarm transmission module 10, a transmission buffer 13, and a keepalive transmission/reception module 11.

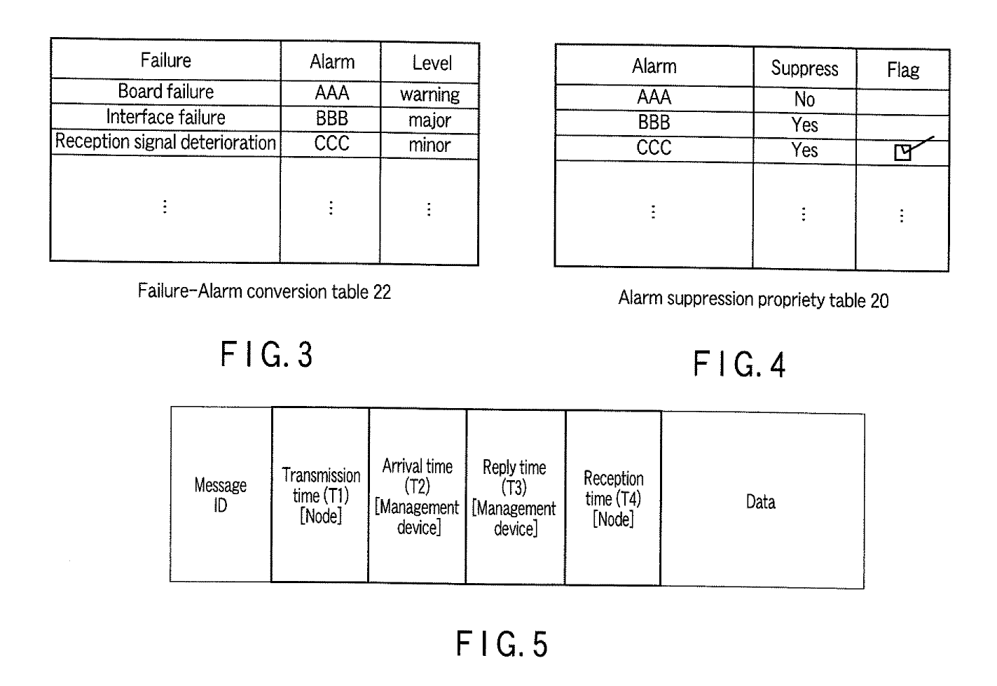

The failure detection module 23 detects occurrence and restoration of a failure in its own node. The alarm information generation module 21 converts the detected failure into alarm information using the failure-alarm conversion table 22 shown in FIG. 3. The alarm information is notified of the management device 3 as a notification message. A sequential number is given to each item of alarm information in order of occurrence. The failure detection module 23 determines whether the alarm information is omitted using the sequential number.

The failure-alarm conversion table 22 shown in FIG. 3 is a table in which alarm information (message) and levels are associated for individual failures. The levels mean priorities for notification to the management device 3, and is defined for every item of alarm information. For example, there are three levels, Major, Minor, and Warning. Of these, Warning is the highest level (level-1), and the level is decreased in the order of Major (level-2) to Minor (level-3).

The alarm buffer 15 is a buffer memory provided to hold alarm information temporarily, and includes a plurality of buffers 151-15n provided for every level of alarm information. The period (buffering time) during which alarm information is held in each of the buffers 151-15n varies in value from one level to another. Further, a flag indicating whether an alarm has occurred or not is associated with each of the buffers 151-15n.

The alarm suppression propriety table 20 is a table for specifying whether to suppress notification to the management device 3 for each alarm. The management device 3 may not be notified of an alarm for which notification has been suppressed. The management device 3 is notified of the alarm for which notification has not been suppressed promptly after occurrence of the alarm.

As shown in FIG. 4, whether to suppress notification or not is specified individually for each alarm. In a state in which notification of the alarm information to the management device 3 is suppressed, an alarm occurrence flag is set for distinction.

The alarm suppression determination module 19 determines whether to suppress transmission of the alarm information to the management device 3 based on the alarm suppression propriety table 20, the state of the alarm buffer 15, the state of the alarm occurrence flag, and the state of the alarm occurring in the node.

The alarm combination module 14 periodically checks whether alarm information exists in each of the buffers 151-15n. If a plurality of items of alarm information are buffered in the same buffer, the alarm combination module 14 combines these items of alarm information into an alarm message to be transmitted to the management device 3.

The non-suppression buffer 16 is a buffer for temporarily holding alarm information which has been determined that transmission does not need to be suppressed. That is, the alarm information which has been determined based on the alarm level by the alarm suppression determination module 19 that transmission is not suppressed is also temporarily buffered here. In this embodiment, transmission suppression of the alarm information is controlled in consideration of the network load as well as the management device 3. In other words, transmission suppression of the alarm information is controlled in two steps. The buffer period is 0, for example, under no-load conditions.

The buffer administrative module 17 for non-suppression periodically checks whether alarm information occurring in the non-suppression buffer 16 exists, and-processes the information if alarm information exists, and generates an alarm message to the management device 3. The timer administrative module 18 notifies the alarm combination module 14 of the timing of the periodic check of the alarm buffer 15. Further, the timer administrative module 18 notifies the buffer administrative module 17 for non-suppression of the timing of a periodic check of the non-suppression buffer 16. Periodic check of the alarm buffer 15 and the non-suppression buffer 16 is performed at a time interval specified according to the alarm level in the timer value table 12.

The alarm transmission module 10 transmits an alarm message to the management device 3. At that time, the transmitted alarm message is held temporarily in the transmission buffer 13. The keepalive transmission/reception module 11 periodically transmits a keepalive message to the management device 3 to perform keepalive. Further, the keepalive transmission/reception module 11 receives and checks a keepalive response, and thereby confirms existence of the management device 3. A keepalive function is one of applications mounted in a device for the purpose of operation check of the network device, for example, and is a well-known technique in the IP (Internet Protocol) telephone system.

In this embodiment, in particular, the keepalive transmission/reception module 11 writes time information in the keepalive message, and measures the load on the management device 3 and the load on the network NW based on the time information. In other words, in this embodiment, a keepalive message is also used as a test signal for measurement of the load.

The management device 3 includes an alarm reception module 31, an alarm decomposition module 32, an alarm sort module 33, an alarm indication module 34, and a keepalive transmission/reception module 35. Of these, the alarm reception module 31 receives an alarm message transmitted from the nodes N1-Nm. If a plurality of items of alarm information are combined into the received alarm message, the alarm decomposition module 32 decomposes it to extract individual items of alarm information. The alarm sort module 33 sorts the individual items of alarm information in order of time stamps. The alarm indication module 34 displays the alarm information on a monitor screen (not shown), for example, and notifies the maintainer of the alarm information. The keepalive transmission/reception module 35 receives a keepalive message from the nodes N1-Nm, and returns a response message to an originating node.

FIG. 5 illustrates an example of a message format of a keepalive message used in the present embodiment. In this embodiment, the keepalive message includes a field for writing time information (time stamp) as well as a field for writing a message identifier (ID) and known data for keepalive.

That is, the keepalive transmission/reception module 11 of the nodes N1-Nm writes a transmission time of a keepalive message in the transmission time field, and transmits the message to the management device. Upon receipt of this, the keepalive transmission/reception module 35 of the management device 3 returns to the originating node a response message to which the time (arrival time) at which this message arrived through the network NW and the time (response time) at which the message is returned to the originating node are added. Upon receipt of the response message, the node writes the reception time in the message field, and then moves to the next processing. The last reception time does not necessarily need to be written. In brief, the node simply needs to know the reception time of the response message. Since the node acquires time data through the keepalive message as described above, it is possible to obtain knowledge about the load on the network NW as well as the load state of the management device 3.

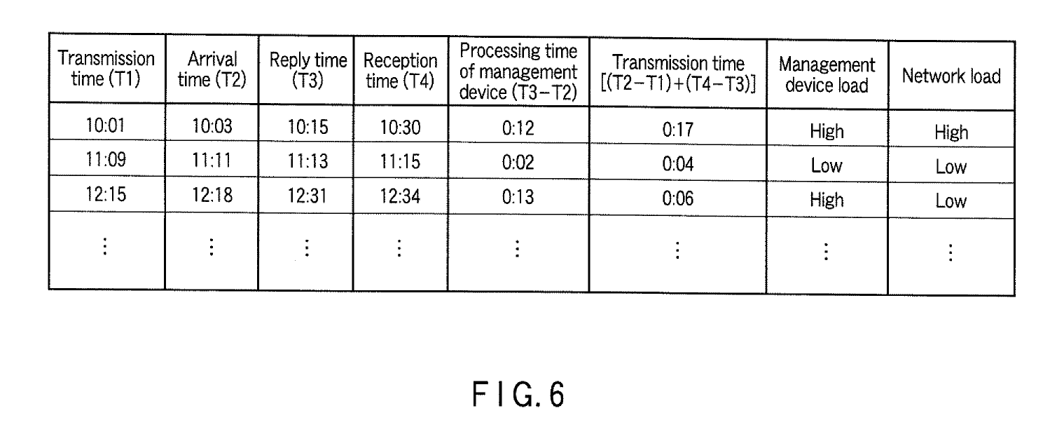

FIG. 6 shows an example of time information written in a keepalive message. FIG. 6 shows an example of transmission time (T1), arrival time (T2), response time (T3), and reception time (T4) in three keepalive messages. The scale is in milliseconds, for example.

The processing load on the management device 3 can be estimated by the time required to process and reply to a keepalive message after receiving the keepalive message. That is, the longer the processing time (T3−T2) is, a higher load is applied. The load on the network NW can be estimated by the transmission time of the keepalive message. That is, the longer the time required for transmission is, a higher load is applied to the network NW. The transmission time can be calculated by adding the transmission time (T2−T1) at the time of keepalive transmission and the transmission time (T4−T3) at the time of reply. Alternatively, in short, the transmission time can be calculated by subtracting the processing time (T3−T2) of the management device from the difference (T4−T1) between the reception time T4 and the transmission time T1.

In FIG. 6, by setting a threshold of 10 milliseconds in the processing time and the transmission time, for example, the pitch of the load can be estimated using the threshold as a boundary.

In the first case of FIG. 6, since both the processing time and the transmission time exceed the threshold, it can be understood that a high load is applied to both the management device 3 and the network NW because of certain factors. It can be understood that in the next case, the loads on both the management device 3 and the network NW are light, and that in the third case, the load on the management device 3 is high, although the load on the network NW is light. Such information is measured by the keepalive transmission/reception module 11, and based on the measured result, the timer administrative module 18 variablly controls the holding period of the buffers 151-15n. Thereby, the alarm transmission suppression can be controlled in detail according to the type of the load.

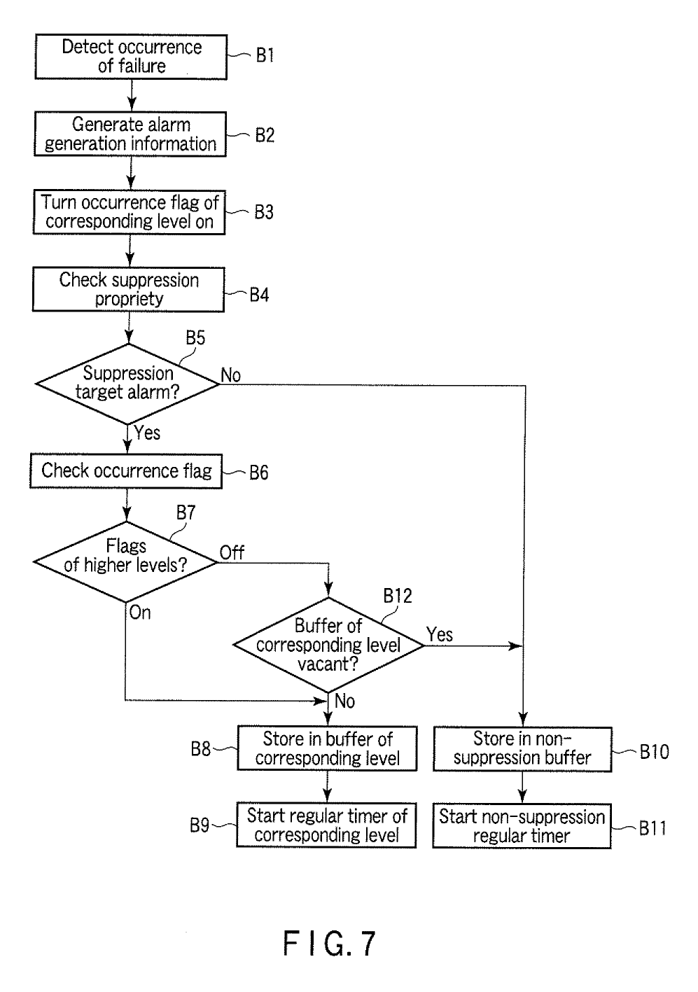

FIG. 7 is a flowchart showing a processing procedure from occurrence of a failure in the nodes N1-Nm to storing of alarm information in a buffer. In FIG. 7, if occurrence of a failure is detected by the failure detection module 23 (step B1), the alarm information generation module 21 generates alarm information from the failure information with reference to the failure-alarm conversion table 22 (step B2).

This alarm information includes an alarm type, an alarm level, a time stamp, a detection place, and so forth. This alarm information is handed to the alarm suppression determination module 19.

The alarm suppression determination module 19 switches an alarm occurrence flag of the level of the handed alarm information to on (step B3). Thereby, transmission of an alarm of a level lower than this level is suppressed. Next, the alarm suppression determination module 19 refers to the alarm suppression propriety table 20, and determines whether to suppress notification based on the level of the alarm information which has occurred (step B4). If notification suppression is not necessary, the alarm suppression determination module 19 stores the alarm information in the non-suppression buffer 16 (step B10).

If notification suppression is necessary, the alarm suppression determination module 19 checks all the alarm occurrence flags of levels higher than the level of that alarm (step B6). If any of the alarm occurrence flags is on, which means that an alarm of a higher level is occurring, the alarm suppression determination module 19 determines that transmission of the handed alarm information be suppressed (step B7). Thereby, the alarm information is stored in the alarm buffer 15 of a corresponding level (step B8).

On the other hand, if all the alarm occurrence flags of the higher levels are set off in step B7, the alarm suppression determination module 19 checks the state of the alarm buffer 15 of the target alarm level (step B12).

If the alarm buffer 15 of the target alarm level is vacant (YES in step B12), the alarm suppression determination module 19 determines that transmission of the target alarm information does not need to be controlled, and stores the alarm information in the non-suppression buffer 16 (in step B10).

If the alarm buffer 15 is not vacant in step B12 (NO), the alarm suppression determination module 19 determines that the transmission is being suppressed at the level of the handed alarm information and stores the alarm information in the alarm buffer 15 of that level (step B8). In either of the steps B8 and B10, if a periodic check timer for a buffer is not started, the alarm suppression determination module 19 requests the timer administrative module 18 to start the periodic time (steps B9, B11).

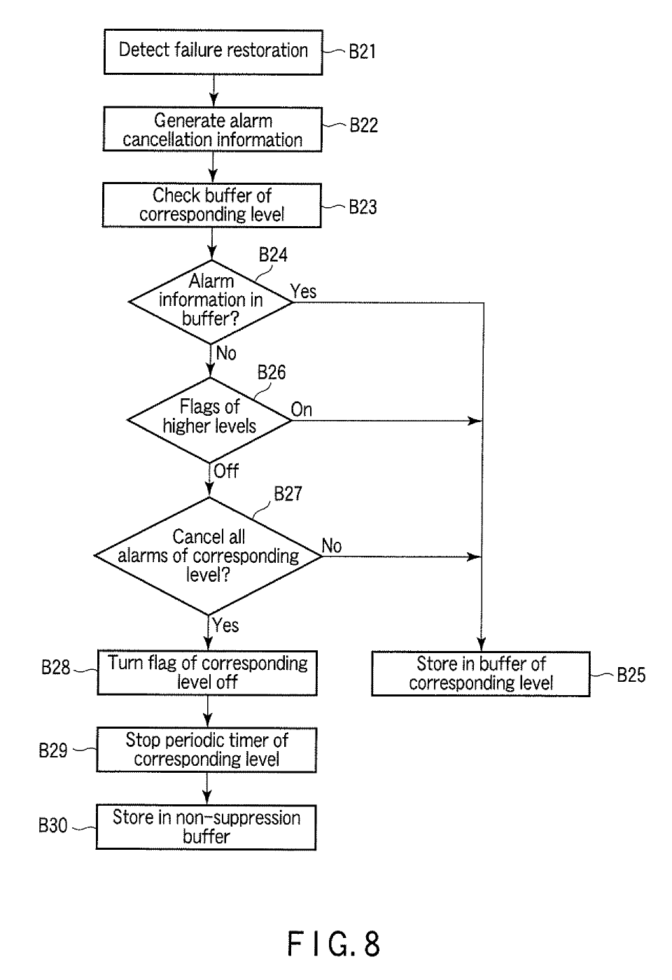

FIG. 8 is a flowchart showing a processing procedure from restoration of a failure in the nodes N1-Nm to transmission of alarm cancellation. In FIG. 8, if restoration of a failure is detected by the failure detection module 23 (step 621), the alarm information generation module 21 generates alarm cancellation information from the failure information with reference to failure-alarm conversion table 22, (step B22). The alarm cancellation information includes an alarm type, an alarm level, a time stamp, a detection place, and so forth. The alarm cancellation information is handed to the alarm suppression determination module 19.

The alarm suppression determination module 19 checks the state of the alarm buffer 15 corresponding to the alarm level written in the handed alarm cancellation information (step B23). If the alarm buffer 15 already has alarm information, the alarm suppression determination module 19 determines that the alarm transmission of the target alarm level is occurring, that is, that the alarm buffer 15 is in a state of waiting for transmission timing, and stores the alarm cancellation information in the alarm buffer 15 (step B25).

If the alarm buffer 15 does not have alarm information, the alarm suppression determination module 19 refers to alarm occurrence flags of levels higher than that of the alarm that should be canceled (step B26). If any of the alarm occurrence flags is on, which means that the transmission of an alarm of a higher level is occurring (in step B26 ON), the alarm suppression determination module 19 determines that transmission of the handed alarm cancellation information be suppressed. Thereby, the alarm cancellation information is stored in the alarm buffer 15 of a corresponding level (step B25). If all the alarm occurrence flags of the higher levels are set off, the alarm suppression determination module 19 determines whether all the alarms of the target level are canceled by cancelling the target alarm (step B27).

If not all the alarms are canceled (NO in step B27), the alarm suppression determination module 19 stores the alarm cancellation information in the target alarm buffer 15 to continue the alarm transmission suppression of that level (step B25). If not all the alarms are canceled (YES in step B27), the alarm suppression determination module 19 determines that the alarm transmission suppression of the target level does not need to be continued. Accordingly, the alarm suppression determination module 19 sets the alarm occurrence flag of the target level off (step B28), requests the timer administrative module 18 to stop the periodic check timer of the target alarm level (step B29), and stores the alarm cancellation information in the non-suppression buffer 16 (step B30).

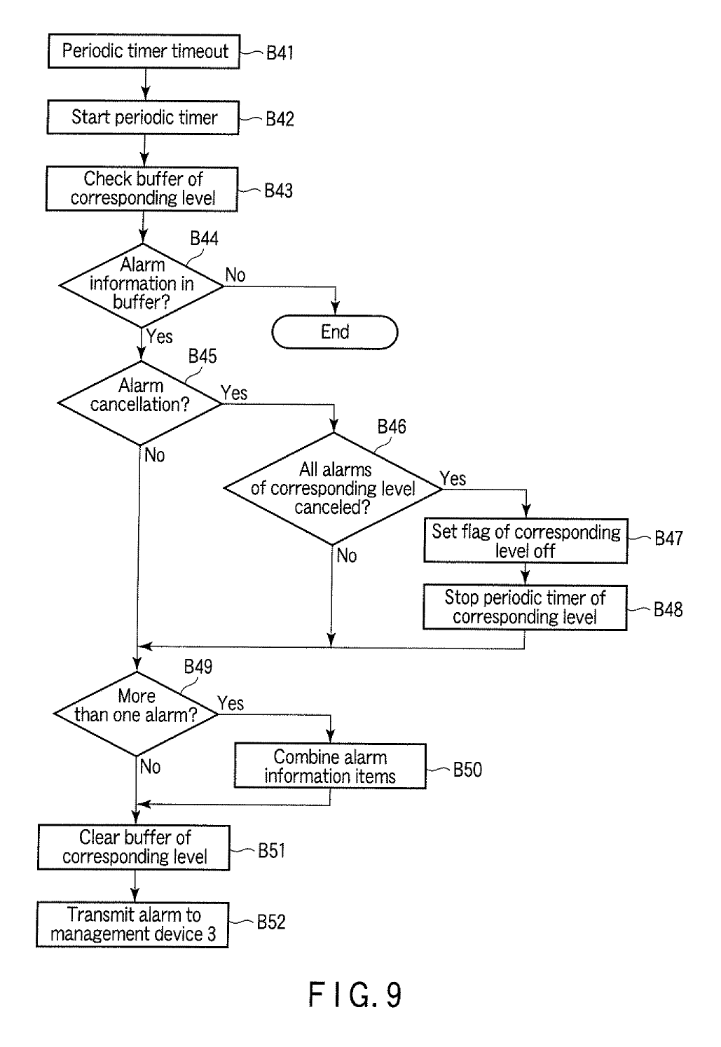

FIG. 9 is a flowchart showing a processing procedure at the time of occurrence of a timeout of a periodic timer in the nodes N1-Nm. Each of the buffers 151-15n is periodically checked by the timer. If a timeout of the timer occurs (step B41), the timer administrative module 18 starts a periodic timer for the next check with reference to the timer value table 12 set by alarm level (step B42). Next, the timer administrative module 18 requests the alarm suppression determination module 19 to check the alarm buffer 15 and then waits for the next timeout.

The alarm suppression determination module 19 checks the state of the alarm buffer 15 of the level of the target of the periodic check (step B43). If the alarm buffer 15 does not have alarm information, the processing ends. If the alarm buffer 15 has alarm information (“YES” in step B44), the alarm suppression determination module 19 confirms whether all the alarms of the target alarm level, including the alarm cancellation information stored in the alarm buffer 15, are canceled (steps B45, B46).

If all the alarms are canceled, the alarm suppression determination module 19 determines that the alarm transmission suppression of the target alarm level does not need to be continued after the present periodic check. Accordingly, the alarm suppression determination module 19 sets an alarm occurrence flag of the target alarm level off (step B47), and requests the timer administrative module 18 to stop the periodic check timer of the target alarm level (step B48). If all the alarms of the target alarm level are not canceled (NO in step B46), the alarm suppression determination module 19 determines that the alarm transmission suppression of the target alarm level is continued after the present periodic check.

Next, the alarm suppression determination module 19 checks the number of items of alarm information stored in the target alarm buffer 15 (step B49). If the number of items of alarm information is one, that is, not two or more (NO), the alarm suppression determination module 19 requests the alarm transmission module 10 for transmission of the alarm, and clears the target alarm buffer 15 (step B51). If the number of items of alarm information is more than one, the alarm suppression determination module 19 requests the alarm combination module 14 to combine the items of alarm information (step B50). Upon receipt of the request, the alarm combination module 14 combines the items of alarm information into one alarm message, requests the alarm transmission module 10 to transmit the alarm, and clears the target alarm buffer 15 (step B52).

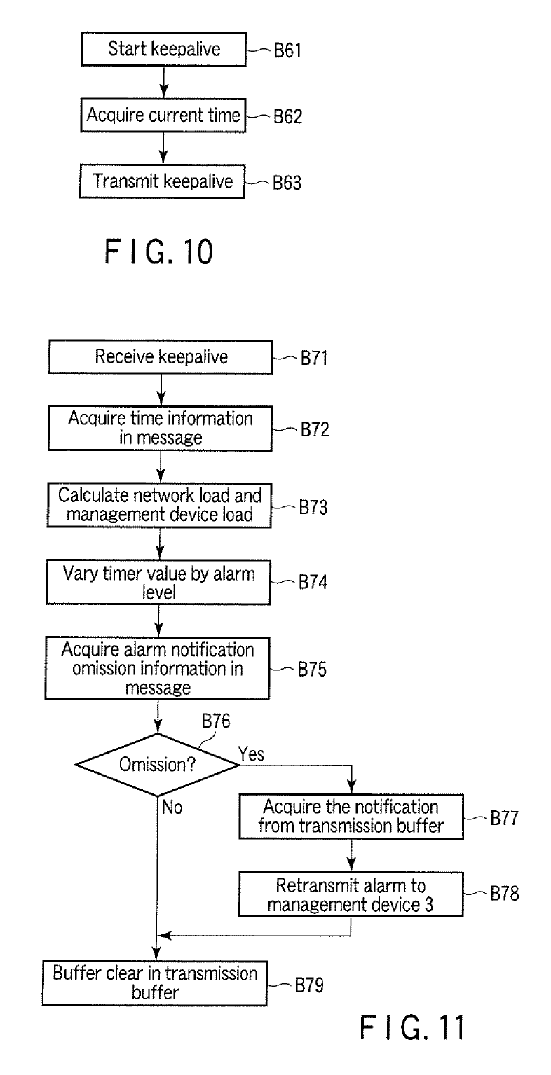

FIG. 10 is a flowchart showing a processing procedure for transmitting a keepalive message in the nodes N1-Nm. Upon timing for starting keepalive (step B61), the node acquires the current time (step B62), writes the value of the current time in a transmission time field of the keepalive message, and then transmits it to the management device (step B63).

FIG. 11 is a flowchart showing a processing procedure for reception of a keepalive message in the nodes N1-Nm. Upon receipt of a keepalive message (step B71), the node acquires time information from each field (step B72). Further, the node calculates the load on the network NW and the load on the management device 3 individually (step B73) from each numerical value, as shown in FIG. 6. The node varies the timer value for each alarm level set in each buffer depending on the result (step B74).

Further, the node acquires alarm notification omission information of a keepalive message returned from the management device 3 (step B75), and if existence of omission is written (“YES” in step B76), acquires corresponding alarm information from the transmission buffer 13 (step B77), and retransmits the alarm information to the management device 3 (step B78). When retransmission of the alarm information is completed, the node clears the transmission buffer 13 (step B79).

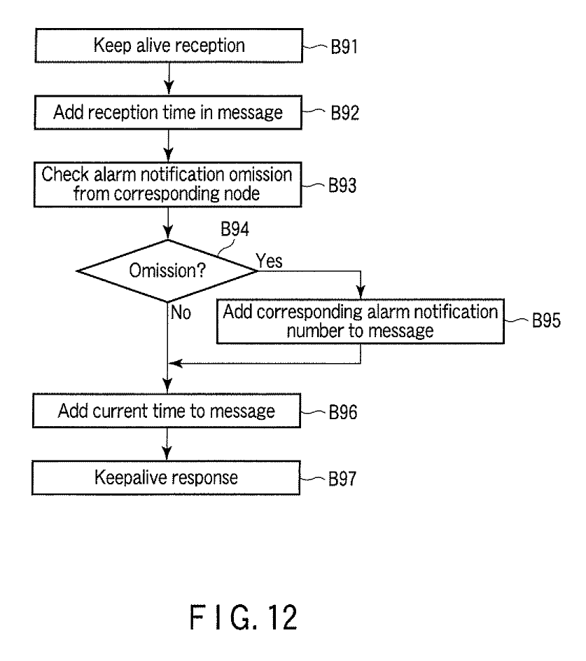

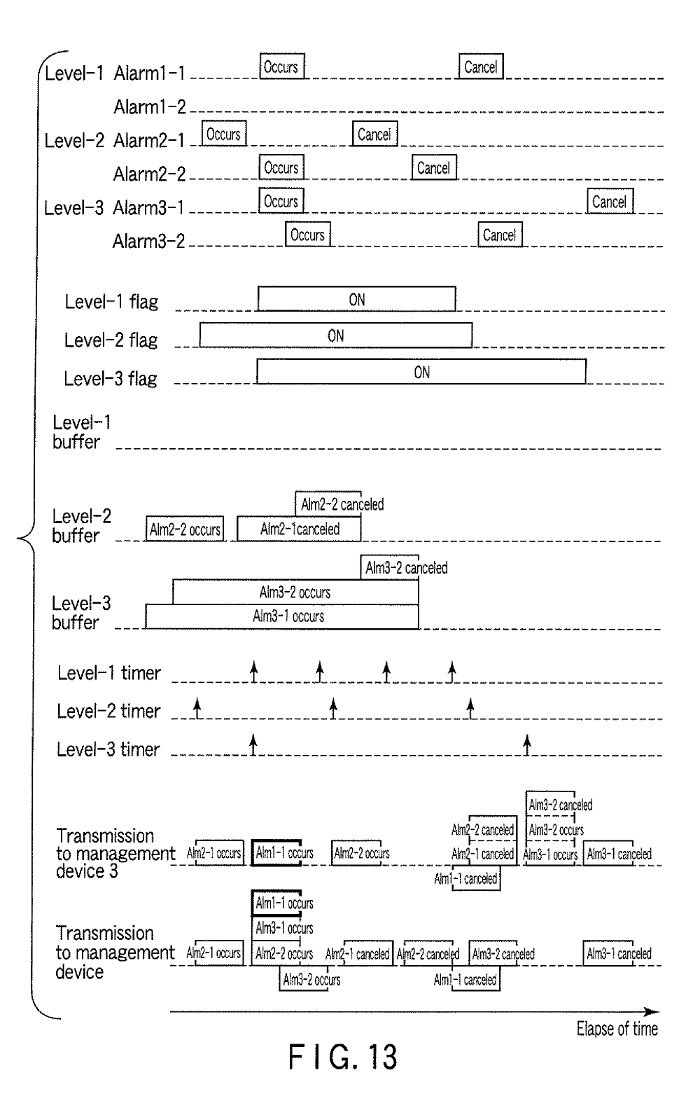

FIG. 12 is a flowchart showing a processing procedure regarding reception and retransmission of a keepalive message in the management device 3. Upon receipt of the keepalive message from a node (step B91), the management device 3 adds the reception time to an arrival time field (step B92), and checks for omission of alarm notification by checking a sequential number given to each item of alarm information (step B93). If there is an omission, the management device 3 adds a sequential number corresponding to the omitted alarm to a keepalive message to be returned to a node (step B95). Next, the management device 3 adds the current time in a reply time field (step B96), and then returns the keepalive response message to the node (step B97).

FIG. 13 is a timing chart showing an alarm occurrence flag, the state of the alarm buffer 15, and alarm transmission in chronological order according to the present embodiment. First, when an alarm (Alarm2-1) of level 2 occurs independently, for example, a flag of level 2 is turned on, a buffering timer is started, and alarm information is transmitted to the management device 3 promptly.

When an alarm (Alarm1-1, Alarm2-2, Alarm3-1) of each level occurs simultaneously from this state, the timer is started after the flags of level 1 and 3 are turned on. In existing techniques, either item of alarm information is transmitted at this point in time, but in this embodiment, only Alarm1-1 of the highest level is transmitted. This state continues until a buffer of level 2 is cleared, and when the buffer is cleared, Alarm2-2 is transmitted. A similar procedure is carried out at the time of cancellation of the alarm, and transmission of alarm information is suppressed until a buffer corresponding to the alarm level is cleared. In particular, a buffer of the least level (level 3) has the longest timer period, and transmission is suppressed until this is cleared. In this embodiment, a timer check period (buffering period) of each buffer is variably controlled in consideration of the load on the network NW as well as the load on the management device 3.

As described above, in this embodiment, the nodes N1-Nm include the buffers 151-15n for individual alarm levels, and when an alarm suppression flag is turned on, alarm information is stored in the buffers. Each of the buffers is checked periodically, and alarm information of a higher level is notified with a higher priority. At that time, the times of transmission, arrival, reply, and reception of the keepalive message are given to the message as a time stamp, the loads on the management device 3 and the network NW are measured from each item of time information, and buffering periods of the buffers 151-15n are variablly controlled to reflect the measured loads.

Further, in this embodiment, if there are a plurality of items of alarm information in each of the buffers 151-15n, the buffer notifies the management device 3 of a combined item of alarm information. Moreover, a sequential number is added to each item of alarm information and whether alarm information is omitted or not is determined based on whether a sequential number is omitted, and if the sequential number is omitted, the management device 3 requests the node for retransmission.

In existing techniques, only the load on the management device 3 is monitored, and traffic involved in notification of the alarm information is suppressed under the initiative of the management device 3. However, a system which considers not only the management device 3 which receives alarm information but also the state of the network until reaching there has not been known. When the load on the network is excessive, an alarm message may be abandoned, and the management device 3 may not be notified of a serious alarm. The situation is serious in such a case, not only because the operation of the network may be interfered, but also because the system may go down.

In contrast, according to the present embodiment, transmission suppression can be controlled in consideration of the state of the network NW too. In particular, in a state in which the traffic of the network is high, there is a case where it is better not to notify an important alarm because of the possibility of packet loss. According to the present embodiment, such a situation can be handled elaborately.

Moreover, according to the present embodiment, when a plurality of alarms have occurred, a high load is applied to the network, or a high load is applied to the management device, notification is provided at longer time intervals and alarm information items are notified after being combined, thereby preventing further overload of the management device 3 and congestion of the network traffic. Furthermore, by retransmitting notification of an omitted alarm and providing preferential notification of an alarm of a high level, the management device 3 can perform urgent processing without a delay. From these, a network management system, a node, and a management apparatus which can effectively suppress the traffic involved in notification of the alarm information can be provided.

The present invention is not limited to the above-described embodiment. For example, in this embodiment, a keepalive message is used also as a signal for measuring a load, but an exclusive probe signal may be set as a signal for measuring a load.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A network management system comprising:
a plurality of nodes forming a communication network; and
a management apparatus which manages a system including the communication network based on a notification message notified of via the communication network by the nodes, each of the nodes including:
a message generator configured to generate notification messages of different levels depending on a type of an alarm that has occurred;
a plurality of buffers each provided for each of the different levels and temporarily holding the notification message in a holding period appropriate to the level;
a notification module configured to notify the management apparatus of the held notification message;
a test signal transmitter configured to transmit a test signal used to measure a load on the management apparatus and a load on the communication network to the management apparatus;
a measurement module configured to individually measure the load on the management apparatus and the load on the communication network based on a reception time of a reply from the management apparatus to the test signal; and
a holding period controller configured to vary a holding period in the buffers according to the level based on the measured load on the management apparatus and the measured load on the communication network, the management apparatus including a transmission/reception module configured to receive the test signal, write a response to the test signal in the test signal, and return the test signal to an originating node.

2. The network management system of claim 1, wherein the test signal includes a first field in which a transmission time from the node is written, a second field in which an arrival time to the management apparatus is written, and a third field in which a reply time from the management apparatus is written,
the test signal transmitter writes the transmission time in the first field and transmits the test signal,
the transmission/reception module writes an arrival time to the management apparatus in the second field, writes a reply time from the management apparatus in the third field and returns the test signal, and
the measurement module measures the load on the management apparatus from a difference between the reply time written in the returned test signal and the arrival time and-the arrival time, and measures the load on the communication network from a value obtained by subtracting the difference from a difference between the reception time and the transmission time written in the test signal.

3. The network management system of claim 1, wherein the test signal is a keepalive message used in a management protocol of the communication network.

4. The network management system of claim 1, wherein each of the nodes includes a combination module configured to combine a plurality of notification messages for each of the buffers,
the notification module notifies the management apparatus of the coupled notification message, and
the management apparatus further includes a resolution module configured to decompose the notification message notified of in the combined state, and extract individual notification messages.

5. A node device which notifies a management apparatus managing a system including a communication network of a notification message via the communication network, the node device comprising:
a message generator configured to generate notification messages of different levels depending on a type of an alarm that has occurred;
a plurality of buffers each provided for each of the different levels, and temporarily holding the notification message in a holding period appropriate to the level;
a notification module configured to notify the management apparatus of the held notification message,
a test signal transmitter configured to transmit a test signal used to measure a load on the management apparatus and a load on the communication network to the management apparatus,
a measurement module configured to measure a load on the management apparatus and a load on the communication network individually based on a reception time of a reply from the management apparatus to the test signal,
a holding period controller configured to vary a holding period in the buffers according to the level based on the load on the measured management apparatus and the load on the communication network.

6. The node device of claim 5, wherein
the test signal includes a first field in which a transmission time from a the node is written, a second field in which an arrival time to the management apparatus is written, and a third field in which a reply time from the management apparatus is written,
the test signal transmitter writes the transmission time in the first field and transmits the test signal, and
the measurement module measures a load on the management apparatus from a difference between the reply time written in the returned test signal and the arrival time, and measures a load on the communication network from a value obtained by subtracting the difference from a difference between the reception time and the transmission time written in the test signal.

7. The node device of claim 5, wherein the test signal is a keepalive message used in a management protocol of the communication network.

8. The node device of claim 5, further comprising a combination module configured to combine the notification messages for each of the buffers.

9. A management apparatus comprising a transmission/reception module configured to receive a test signal returned from the nodes to measure a load on the management apparatus and a load on the communication network, write a response to the test signal in the test signal, and return the test signal to an originating node, in a management apparatus which manages a system including a communication network connecting a plurality of nodes based on a notification message notified of via the communication network by the nodes.

10. The management apparatus of claim 9, wherein the test signal includes a first field in which a transmission time from the node is written, a second field in which an arrival time to the management apparatus is written, and a third field in which a reply time from the management apparatus is written,
the transmission/reception module writes the arrival time to the management apparatus in the second field, writes the reply time from the management apparatus in the third field, and returns the test signal.

11. The management apparatus of claim 9, wherein the test signal is a keepalive message used in a management protocol of the communication network.

12. The management apparatus of claim 9, further comprising a decomposition module configured to decompose a notification message notified of in a combined state and extracts individual notification messages.
